(19) United States
(12) Patent Application Publication
(10) Pub. No.: US 2024/0151681 A1
(43) Pub. Date: May 9, 2024

(54) MULTIFUNCTIONAL SOFT BIOELECTRONICS

(71) Applicants: The Curators of the University of Missouri, Columbia, MO (US); BOARD OF REGENTS OF THE UNIVERSITY OF NEBRASKA, Lincoln, NE (US)

(72) Inventors: Zheng Yan, Columbia, MO (US); Yadong Xu, Columbia, MO (US); Jingwei Xie, Omaha, NE (US)

(21) Appl. No.: 18/386,798

(22) Filed: Nov. 3, 2023

Related U.S. Application Data
(60) Provisional application No. 63/422,754, filed on Nov. 4, 2022.

(51) Int. Cl. G01N 27/327; H01B 1/16; H01B 3/30

(52) U.S. Cl. CPC G01N 27/3278; H01B 1/16; H01B 3/302

(57) ABSTRACT

Systems, methods, and devices for providing a phase-separated porous nanocomposite including a porous polymer substrate with a plurality of pores and conductive silver nanowire disposed therein. The pores within the nanocomposite permit stretching and strain loading condition without a substantial impact on electrical properties such as electrical resistance.

### RELATED APPLICATIONS

This non-provisional patent application claims priority benefit, with regard to all common subject matter, of earlier-filed U.S. Provisional Patent Application No. 63/422,754, filed on Nov. 4, 2022, and entitled “MULTIFUNCTIONAL SOFT BIOELECTRONICS.” The identified earlier-filed provisional patent application is hereby incorporated by reference in its entirety into the present application.

### STATEMENT OF GOVERNMENT SUPPORT

This invention was made with government support under R01 EB033371 awarded by the National Institutes of Health. The government has certain rights in the invention.

### BACKGROUND

### 1. Field

Embodiments of the present disclosure relate to soft bioelectronics. More specifically, embodiments of the present disclosure relate to flexible strain-invariant bioelectronics.

### 2. Related Art

Wearable and implantable bioelectronic devices are used in a variety of applications such as, for example, biomedical diagnosis, electronic skins, and human machine interface. However, said bioelectronic devices exhibit a number of difficulties including microscopic rigidity with significant mechanical mismatch when interfaced with soft biological tissues, strong electrical-mechanical coupling that results in signal degradation when stretched, insufficient electrical conductivity or stretchability, and dehydration issues that constrain long-term robustness and durability. Additionally, providing a stable and sustainable power supply for implantable and wearable bioelectronic devices without causing discomfort or interfering with repetitive and dynamic human motions remains a challenge.

### SUMMARY

Embodiments of the present disclosure solve the above-mentioned problems by providing a porous microstructure with one or more strain-invariant electrical properties thereby allowing a biosensor device to continue operation under strain conditions.

In some aspects, the techniques described herein relate to a bioelectronic device including: a phase-separated porous silver nanowire nanocomposite (PSPN), the PSPN including: an energy-dissipative porous microstructure configured to provide a strain-invariant electrical property of the PSPN, the energy-dissipative porous microstructure including: a porous multiscale elastomer matrix; and a plurality of silver nanowires disposed on a plurality of surfaces of the porous multiscale elastomer matrix.

In some aspects, the techniques described herein relate to a bioelectronic device, the porous multiscale elastomer matrix includes a polyurethane material.

In some aspects, the techniques described herein relate to a bioelectronic device, wherein the bioelectronic device is configured to be integrated into a multiplexed biochemical sensing system.

In some aspects, the techniques described herein relate to a bioelectronic device, further including: a stretchable biochemical sensing interface formed of the PSPN; and a spiral coil communicatively coupled to the stretchable biochemical sensing interface, the spiral coil configured to transmit and receive wireless signals.

In some aspects, the techniques described herein relate to a bioelectronic device, further including: a stretchable near-field communication (NFC) antenna formed of the PSPN.

In some aspects, the techniques described herein relate to a bioelectronic device, wherein the PSPN has a percolation threshold below 0.01.

In some aspects, the techniques described herein relate to a bioelectronic device, wherein the PSPN has a percolation threshold below 0.0007.

In some aspects, the techniques described herein relate to a method of fabricating a bioelectronic device, the method including: preparing a precursor solution, the precursor solution including: a polymer solution including a polymer and a solvent; and a conductive filler solution including a plurality of silver nanowires and a nonsolvent; heating or naturally drying the precursor solution to evaporate the solvent from the polymer solution, wherein heating or naturally drying the precursor solution causes phase separation of the precursor solution into a polymer rich phase and a polymer poor phase; and forming a phase-separated porous microstructure with the precursor solution, the phase-separated porous microstructure including a strain-invariant electrical property and configured to be included in the bioelectronic device, wherein the polymer poor phase forms a plurality of pores.

In some aspects, the techniques described herein relate to a method, wherein the strain-invariant electrical property is an electrical conductivity of the phase-separated porous microstructure.

In some aspects, the techniques described herein relate to a method, wherein the polymer includes polyurethane and styrene ethylene butylene styrene.

In some aspects, the techniques described herein relate to a method, wherein the solvent includes tetrahydrofuran.

In some aspects, the techniques described herein relate to a method, further including: varying a volumetric ratio between the polymer solution and the conductive filler solution, wherein the volumetric ratio is selected based on one or more electrical properties for the bioelectronic device.

In some aspects, the techniques described herein relate to a method, further including: post-annealing the phase-separated porous microstructure, wherein a post-annealing temperature is selected based on the one or more electrical properties for the bioelectronic device.

In some aspects, the techniques described herein relate to a wearable wireless bioelectronic device including: a phase-separated porous silver nanowire nanocomposite (PSPN), the PSPN including: an energy-dissipative porous microstructure configured to provide a strain-invariant electrical conductivity of the PSPN, the energy-dissipative porous microstructure including: a porous structure; and a plurality of nanostructures disposed on the porous structure.

In some aspects, the techniques described herein relate to a wearable wireless bioelectronic device, further including: a plurality of electrodes including a reference electrode and a working electrode.

In some aspects, the techniques described herein relate to a wearable wireless bioelectronic device, wherein the wearable wireless bioelectronic device is configured to be integrated into a strain-insensitive wireless power system.

In some aspects, the techniques described herein relate to a wearable wireless bioelectronic device, further including: a voltage multiplier circuit configured to increase a voltage associated with the wearable wireless bioelectronic device.

In some aspects, the techniques described herein relate to a wearable wireless bioelectronic device, wherein the wearable wireless bioelectronic device is a perspiration monitoring device configured to monitor perspiration of a patient in real-time based on changes in glucose and ethanol concentrations.

In some aspects, the techniques described herein relate to a wearable wireless bioelectronic device, wherein the wearable wireless bioelectronic device is a battery-free passive electronic device that is not coupled to a battery.

In some aspects, the techniques described herein relate to a wearable wireless bioelectronic device, further including: a Bluetooth low energy antenna configured to provide a wireless communication connection with one or more external devices.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 illustrates an exemplary diagram of a non-porous nanocomposite material.

FIG. 2 illustrates an exemplary diagram of a porous nanocomposite material relating to some embodiments of the present disclosure.

FIG. 3 illustrates an exemplary diagram of a process for forming the non-porous nanocomposite material relating to some embodiments of the present disclosure.

FIG. 4 illustrates an exemplary graph of electrical resistance over strain comparing a nonporous microstructure with a porous microstructure relating to some embodiments of the present disclosure.

FIG. 5 illustrates an exemplary graph of percolation threshold over pore size relating to some embodiments of the present disclosure.

FIG. 6 illustrates an exemplary phase diagram of the nanocomposite microstructure relating to some embodiments of the present disclosure.

FIG. 7 illustrates an exemplary graph of sensitivity over strain relating to some embodiments of the present disclosure.

FIG. 8 illustrates an exemplary block diagram of a mobile data acquisition circuit relating to some embodiments of the present disclosure.

FIG. 9 illustrates an exemplary implantable biosensor device relating to some embodiments of the present disclosure.

FIG. 10 illustrates an exemplary biochemical sensing device 130 relating to some embodiments of the present disclosure.

FIG. 11 illustrates an exemplary implantable optoelectronic device 140 relating to some embodiments of the present disclosure.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments of the present disclosure contemplate a stretchable strain-invariant biosensor device and method of fabrication thereof. The biosensor device including a porous microstructure that permits strain-invariant electrical properties such that the biosensor device can continue to operate under various loading conditions with relatively low impact on the electrical properties.

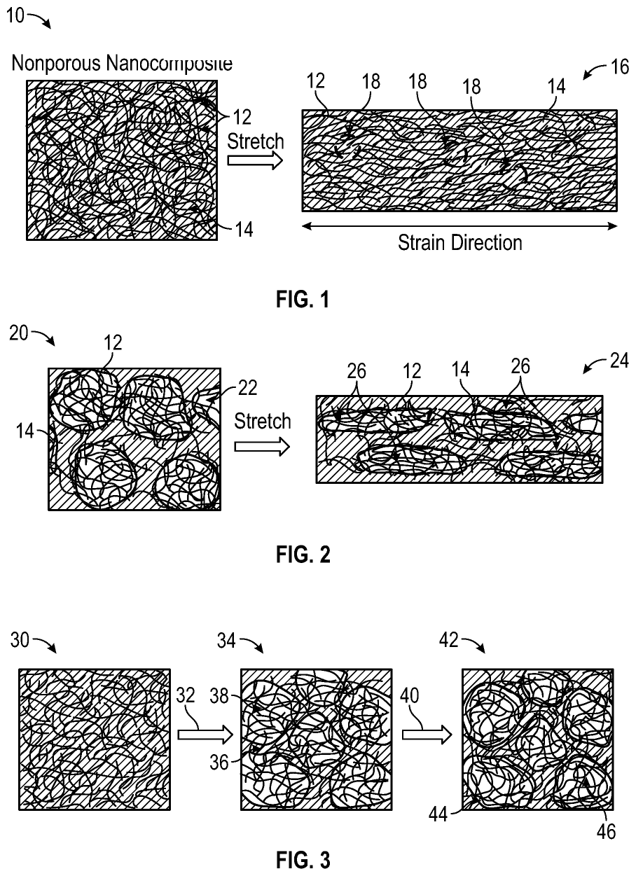

FIG. 1 illustrates an exemplary diagram of a non-porous nanocomposite material 10. The exemplary initial non-porous nanocomposite material 10 comprises a plurality of silver nanowires (Ag NWs) 12. However, it should be understood that, in some embodiments, other forms of nanomaterials and nanostructures are also contemplated. The Ag NWs 12 are disposed on a polymer substrate 14, such as, for example, a polyurethane matrix.

The non-porous nanocomposite material 10 may be stretched along a stretch direction to form a stretched non-porous nanocomposite material 16, as shown. For example, the polymer substrate 14 may be stretched by applying a tensile force to the exemplary non-porous nanocomposite material 10. According, the exemplary non-porous nanocomposite material 10 experiences tensile strain along a particular direction, which stretches the polymer substrate 14 and the Ag NWs 12. The stretching of the Ag NWs 12 causes strain-induced breakage sites 18 of the Ag NWs 12, as shown. Specifically, because the flexibility of the Ag NWs 12 is generally lower than that of the polymer substrate 14, the Ag NWs 12 are strained beyond a failure point associated therewith.

FIG. 2 illustrates an exemplary diagram of a porous nanocomposite material 20 relating to some embodiments of the present disclosure. The porous nanocomposite material 20 comprises the Ag NWs 12 disposed on the polymer substrate 14 similar to the non-porous nanocomposite material 10 as described above. However, the porous nanocomposite material 20 comprises a plurality of pores 22, as shown. The pores 22 comprise open cavities within the structure of the polymer substrate 14. In some embodiments, the Ag NWs 12 are passively focused onto the plurality of pores 22.

The porous nanocomposite material 20 may be stretched along a stretch direction to form the stretched porous nanocomposite material 24, as shown. For example, the porous nanocomposite material 20 may be stretched as a result of tensile strain, similar to as described above with respect to the non-porous nanocomposite material 10. When stretched, the porous nanocomposite material 20 is elongated. Specifically, the polymer substrate 14 and plurality of pores 22 disposed therein are elongated along the strain direction. However, contrarily to the non-porous nanocomposite material 10, the pores 22 within the porous nanocomposite material 20 allow stretching without significant strain applied to the Ag NWs 12 such that the strain-induced breakage sites 18 are not generated within the stretched porous nanocomposite material 24. In some embodiments, the porous nanocomposite material 20 comprises strain-adaptive percolation connections 26 that remain intact even after stretching of the porous nanocomposite material 20, as shown.

The porous structure of the porous nanocomposite material 20 alters deformation, accommodates mechanical strain, and dissipates local stress. Accordingly, strain-adaptive percolation pathways of the Ag NWs 12 adapt to such structural change associated with macroscopic stretching and therefore, interconnected conductive networks of the Ag NWs 12 are preserved. As a result of the preservation of the conductive networks, electrical properties of the porous nanocomposite material 20 become more stable under strain. Specifically, minimal increase in electrical resistance is produced over a broad range of uniaxial strains for the porous nanocomposite material 20, whereas conventional nonporous nanocomposite experiences a rapid increase in electrical resistance with the introduction of strain. In some such cases, the increase in electrical resistance may be a result of the strain-induced breakage sites 18, as shown in FIG. 1. Accordingly, the porous nanocomposite material 20 is better suited for stretching because the strain-induced breakage sites 18 are not produced and the associated significant change in electrical resistance is avoided.

FIG. 3 illustrates an exemplary diagram of a process for forming the non-porous nanocomposite material 10 relating to some embodiments of the present disclosure. At an initial stage of the forming process begins by preparing a precursor solution 30 comprising a polymer solution, such as, for example, polyurethane (PU) with tetrahydrofuran (THF) solvent and a conductive filler solution, such as, for example, AG NWs in ethanol. Evaporation 32 of THF occurs between the initial stage and a second stage. For example, the THF may be evaporated by heating the precursor solution using at least one heating element. Alternatively, in some embodiments, evaporation may occur passively without additional heating. In some embodiments, the precursor solution may be dry-casted. Accordingly, phase separation, described in further detail below, occurs once volatile solvent, THF with a boiling point of about 66° C., starts to evaporate. Additionally, in some embodiments, the polymer solution further comprises styrene ethylene butylene styrene.

In addition to conductive fillers, in some embodiments, additives may include other functional materials with different compositions and shapes, including but not limited to antibacterial agents (e.g., polylysine), semiconductive fillers (e.g., poly(3-hexylthiophene-2,5-diyl) nanofibrils), electrochemical active materials (e.g., poly(3,4-ethylenedioxythiophene) polystyrene sulfonate, reduced graphene oxide), and functional materials that provide adhesive enhancement, noise damping, thermal management, and immunomodulation. Additionally, a variety of other suitable additives are contemplated that are not explicitly described herein.

At the second stage of the forming process, phase separation 34 occurs causing the precursor solution to separate into a polymer rich phase 36 and a polymer poor phase 38. The polymer rich phase 36 forms the base structure of the polymer substrate 14, as described above, while the polymer poor phase 38 forms cavities leading to the plurality of pores 22. In some embodiments, polymer rich and polymer poor refer to the concentration of polymer, such as polyurethane present in the solution. Nonsolvent evaporation 40 occurs after phase separation 34 as the nonsolvent of the polymer solution is heated to evaporation. The polymer rich phase 36 solidifies within the composite, while the polymer poor phase 38 forms nano/microscale droplets in which most Ag NWs with amphiphilic ligands, such as polyvinyl pyrrolidone (PVP), reside due to the immiscibility between Ag NWs and the PU polymer solution.

At a final stage of the forming process, a phase-separated porous microstructure 42 is formed comprising a plurality of multiscale pores 44 with self-organized Ag NWs 46 focused along the plurality of multiscale pores 44, as shown. As described above, the plurality of multiscale pores 44 prevent breakage of the Ag NWs to thereby improve the electrical properties of the microstructure under strain.

In some embodiments, the process described with respect to FIG. 3 is included within a method of fabrication of the PSPN or additionally of a bioelectronic device including the PSPN. Further, in some embodiments, any number of additional steps or stages may be included. For example, a post-processing annealing process or assembly process may be included to integrate the PSPN into the bioelectronic device.

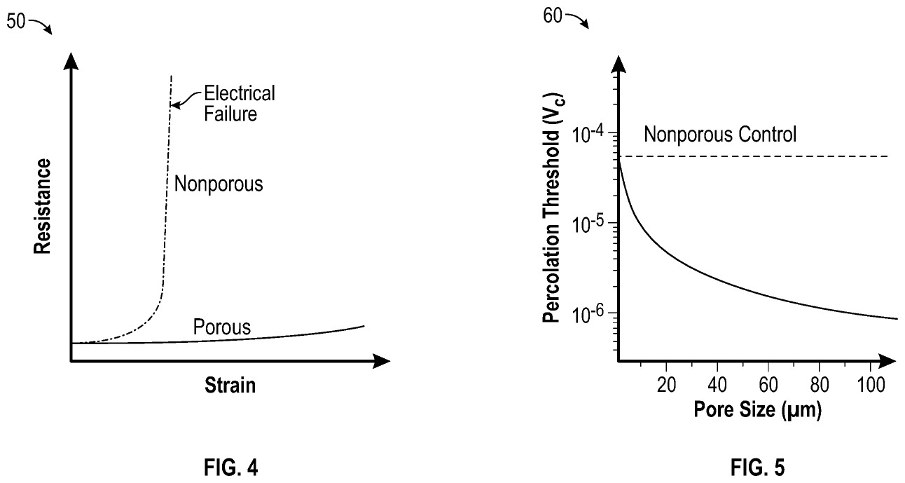

FIG. 4 illustrates an exemplary graph 50 of electrical resistance over strain comparing a nonporous microstructure with a porous microstructure relating to some embodiments of the present disclosure. As shown, the nonporous microstructure experiences a sharp increase in electrical resistance due to a minimal amount of strain, while the porous microstructure experiences only a small increase in electrical resistance over a relatively larger amount of strain. The nonporous microstructure may experience electrical failure due to a relatively low amount of strain, as shown.

FIG. 5 illustrates an exemplary graph 60 of percolation threshold over pore size relating to some embodiments of the present disclosure. The percolation threshold, as described herein, may refer to the minimum number of conductive fillers required to create conductive pathways. In some embodiments, the percolation threshold may be theoretically calculated based on three-dimensional percolation theory to correlate percolation threshold with pore size of the polymer matrix, i.e., the porous nanocomposite material 20. As shown, the percolation threshold decreases with an increase in pore size for the porous nanocomposite material 20 while the percolation threshold of the nonporous control remains static because no pores are present.

$${V}_{c} = \frac{1.409 π {d}^{2}}{Vl} f ( {D}_{p} )$$

The percolation threshold, V_{c} may be calculated using the above equation, where d is the diameter, l is the length, V is the volume of nanocomposite, and f(Dₚ) is the surface area of the porous microstructure as a function of pore size Dₚ. Accordingly, in some embodiments, a specific average pore size may be selected based at least in part on a desired percolation threshold for the nanocomposite. For example, parameters of the formation process may be adjusted to provide the selected average pore size. In some embodiments, the percolation threshold of the PSPN is below 0.01. Further, embodiments are contemplated in which the percolation threshold of the PSPN is below 0.001.

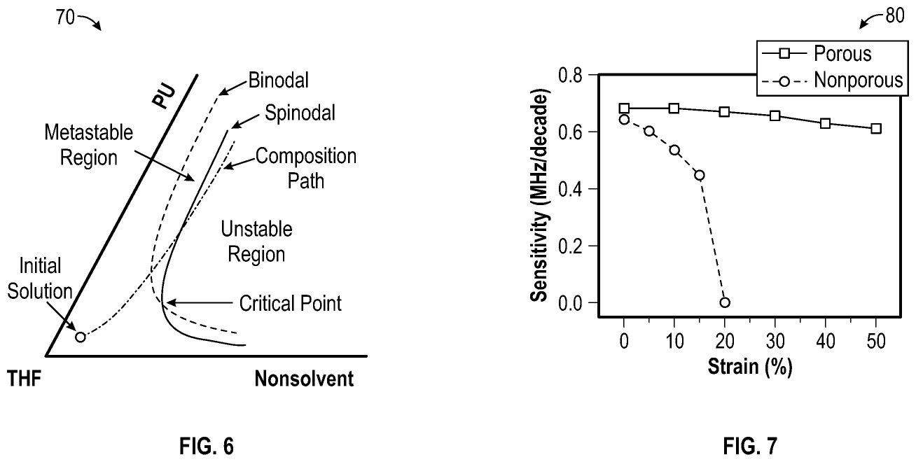

FIG. 6 illustrates an exemplary phase diagram 70 of the nanocomposite microstructure relating to some embodiments of the present disclosure. The phase diagram 70 shows the trajectory of the composition path of the nanocomposite solution during formation of the nanocomposite microstructure. The composition crosses the binodal as THF evaporates and enters the metastable region where liquid-liquid demixing occurs upon drying, as shown. Next, the composition crosses the spinodal, enters the unstable region, followed by the spinodal decomposition, leading to the formation of multiscale porous nanocomposites. During this process, Ag NWs first self-organize intimately on pore surfaces and gradually create strain-adaptive percolation networks with increased numbers of nanowires.

The self-assembly of Ag NWs at the microscopic level is driven by minimizing the free energy to stabilize the system (i.e., the Pickering effect). The morphology and pore size are tunable by varying the volumetric ratios between the polymer solution and the conductive filler solution. Accordingly, for example, the volumetric ratios may be selected to achieve a particular pore size and, thus, a particular degree of percolation. In some embodiments, the microscale self-assembly process occurs at ambient conditions resulting in a highly stretchable conductive phase-separated porous nanocomposite (PSPN).

FIG. 7 illustrates an exemplary graph 80 of sensitivity over strain relating to some embodiments of the present disclosure. The graph 80 compares the sensitivity of an exemplary sensor formed of the PSPN to that of a nonporous sensor over increasing strain percentages. As shown, the sensitivity of the porous sensor remains relatively constant, while the sensitivity of the nonporous sensor degrades substantially at just 20% strain. Accordingly, in some embodiments, an enhanced-sensitivity sensor device is contemplated comprising a strain-invariant porous nanostructure such that the sensitivity is not degraded while and after the device experiences strain.

In some embodiments, an anisotropic PSPN device is contemplated for which the electrical properties are strain-invariant for a particular strain direction. For example, the anisotropic PSPN device may be configured to be stretched in a longitudinal direction with little impact to the electrical resistance. Conversely, the anisotropic PSPN device may experience a different impact in electrical resistance when stretched along a different strain direction.

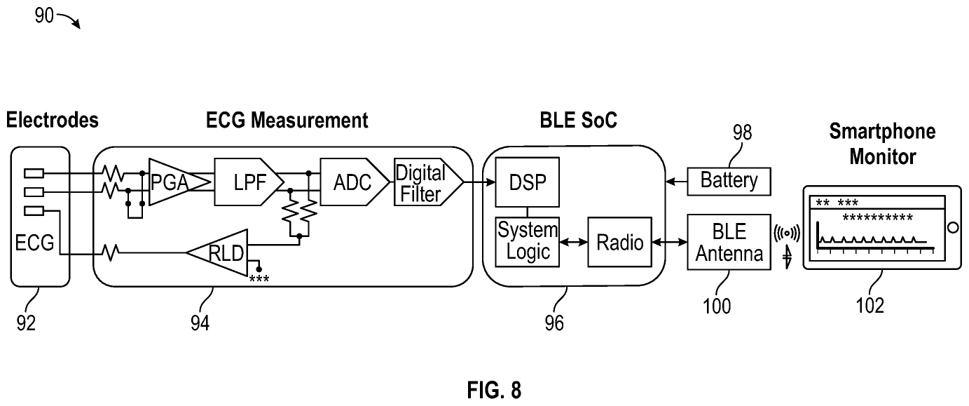

FIG. 8 illustrates an exemplary block diagram of a mobile data acquisition circuit 90 relating to some embodiments of the present disclosure. For example, the mobile data acquisition circuit 90 may include or be coupled to the biosensor device as described herein. In some embodiments, the mobile data acquisition circuit 90 comprises a plurality of electrodes 92. For example, three electrodes 92 may be included, as shown. Alternatively, in some embodiments, any suitable number of electrodes may be included, such as two electrodes or another suitable number. In some embodiments, the electrodes 92 may be configured to monitor cardiac electrical activity. For example, the three electrodes 92 may form an electrocardiogram (ECG) or mechanical impedance cardiogram (ICG) for monitoring cardiac activity. The electrodes 92 may be formed using the porous microstructure, as described above, to operate stably and reliably under dynamic deformations, as well as to provide a mechanically imperceptible skin-interfaced biosensor such that the user does not experience discomfort.

In some embodiments, the bioelectronic device, as described herein comprises a perspiration monitoring device configured to monitor perspiration of a patient in real-time based on one or more changes in glucose and ethanol concentrations.

In some embodiments, the mobile data acquisition circuit 90 further comprises an ECG measurement portion 94, as shown. The ECG measurement portion 94 may be communicatively coupled to the electrodes 92 such that the ECG measurement portion 94 may be configured to measure and/or transform a signal received from the electrodes 92. In some embodiments, the ECG measurement portion 94 comprises any combination of a low-pass filter (LPF), an analog-to-digital converter (ADC), a programmable gain amplifier (PGA), a right leg driver (RLD), and a digital filter, as shown.

In some embodiments, the mobile data acquisition circuit 90 further comprises a Bluetooth portion 96, such as a Bluetooth low energy (BLE) system on a chip (SoC). The Bluetooth portion 96 may include a digital signal processor (DSP) coupled to a digital filter of the ECG measurement portion 94. Additionally, the Bluetooth portion 96 may include a system logic portion and a radio portion such as a radio frequency receiver or transceiver.

In some embodiments, at least one battery 98 may be included. The battery 98 may be coupled to the Bluetooth portion 96 and configured to provide electrical power to the Bluetooth portion 96 and/or the ECG measurement portion 94. Alternatively, in some embodiments, a passive electronics system is contemplated such that the at least one battery 98 may not be included. Further, in some embodiments, a BLE antenna 100 may be included for providing a Bluetooth communication connection with one or more external devices. For example, the BLE antenna 100 may provide a Bluetooth communication connection with a user device 102, as shown, such as, for example, a smart phone, tablet, laptop computer, desktop computer, or another suitable user device. Alternatively, or additionally, in some embodiments, other forms of wireless communication are contemplated. For example, in some embodiments, other forms of near field radio frequency communication besides Bluetooth may be used. Alternatively, or additionally, in some embodiments, a near-field communication (NFC) antenna may be included. In some such embodiments, the NFC antenna may be a stretchable NFC antenna formed of the PSPN material.

In some embodiments, any portion of the mobile data acquisition circuit 90 may include the PSPN material as described above, such as the porous nanocomposite material 20. For example, in some embodiments, one or more wired communication connections between the electrodes 92, the ECG measurement portion 94, and the Bluetooth portion 96, or components thereof may comprise the porous nanocomposite material 20 to provide strain-invariant electrical resistance and flexibility to the electrical connections of the mobile data acquisition circuit 90. Additionally, or alternatively, the components themselves may be formed of the porous nanocomposite material 20. For example, in some embodiments, the electrodes 92 may comprises the porous nanocomposite material 20.

In some embodiments, self-assembly of Ag NWs at the interface of a continuous “solid-gas” phase with increased concentration of Ag NWs is contemplated, which is guided by the porous, soft PU elastomer matrix. Such selective distribution substantially reduces the volume fraction of conductive fillers required for continuous electron transport, in contrast to conventional nonporous nanocomposite where filler materials are nearly homogeneously distributed throughout the polymer. In some embodiments, the porous microstructure (mean pore size, about 16.8 μm) provides a notable reduction in percolation threshold (Vc) from 0.02971 to 0.00062 (a factor of about 48). The electrical conductivity may differ depending on Ag NWs volume fractions. For example, a value of about 642,000 S per meter may be achieved after cold welding with saturated sodium chloride solution.

In some embodiments, the PSPN comprises randomly distributed Ag NWs confined within the porous polymer matrix. A large number of nanowires creates conductive percolation networks that bridge multiscale interconnected pores. The significant mechanical mismatch in Young's modulus between soft PU elastomer (about 16 MPa) and rigid Ag NWs (about 83 GPa) generates anisotropic regions with different elasticity. Upon stretching, local stress dissipation is achieved through autonomous structural alternation of the soft PU elastomer, while the strain-adaptive Ag NWs retain the original percolation networks with minimally altered orientation due to their intrinsic rigidity. As a result, the porous nanostructure enables delayed electrical failure, enhanced stretchability (>600%), and notably stabilized electrical resistance over large uniaxial, biaxial strains and bending. By contrast, electrical failure occurs on the conventional nonporous nanocomposites at an early stage, such as below 100% strain, due to the absence of energy-dissipative porous microstructures resulting in breakage of percolation pathways.

Additionally, the PSPN contemplated herein is resilient for multiple washing cycles and various damage scenarios, such as, for example, puncturing, impact loading, twisting, and bending with no impact (or relatively minimal impact compared to standard materials and non-porous composites) on the electrical properties, including electrical resistance. Further, in some embodiments, the electrical conductivity, modulus, and electromechanical properties of the resulting porous nanocomposites are tunable by varying the volumetric ratios between the polymer solution and the Ag NWs solution, and post-annealing temperatures. For example, a post-annealing temperature may be selected to achieve a particular electromechanical property of the porous nanocomposite.

In addition to the ultralow percolation threshold and strain-insensitive characteristics, the multiscale interconnected cellular structure of the PSPN enables enhanced porosity and breathability to facilitate skin perspiration and improve long-term biocompatibility. The phase-separated microscale porosity present in the polymer matrix may provide a substantial increase in water vapor transmission rate (WVTR) from about 615 to about 4,424 gram per square meter per day and a reduction in Young's modulus from about 9.1 to about 1.6 MPa. Given that the material's elastic modulus scales with density and the power is associated with the porous material's nano/microstructures, the increased softness is attributed to the multiscale nano- and microstructures. This is therefore conducive to the compliant interface with human skin (about 5 kPa to about 140 MPa). Accordingly, in some embodiments, a biosensor is provided that has a substantially similar elasticity to that of human skin such that the biosensor increases less fatigue associated with a mismatch in elasticity and becomes more comfortable to the patient.

In some embodiments, battery-free, wireless power delivery and data transmission technologies utilizing the PSPN described herein are contemplated to power and operate wearable and implantable devices. Taking advantage of the consistent electrical conductivity and strain-invariant feature, stretchable spiral coils may be fabricated using PSPN and implemented in a radiofrequency (RF) wireless power transfer (WPT) system.

NFC-based wireless powering and data transmission systems enable a myriad of new applications for wearable and implantable bioelectronic devices. Examples include recordings of neurophysiological activity, biochemical sensing, neuromodulation, and pain management. These devices rely on either rigid materials or soft materials with limited stretchability. Given the exceptional electrical conductivity and electrically resilient property, the PSPN may be used to fabricate wearable wireless power transmitters and implantable receivers.

Alternatively, or additionally, the potential of the porous nanocomposite is shown as implantable receiver coils for optoelectronics. The inherently soft and stretchable device with low-modulus mechanics allows implantation and dynamic deformations (e.g., bending and stretching) within any of an animal (for testing, for example) or a human patient. For example, an implantable receiver coil may be inserted within a mouse or other animal to test the properties of the porous nanocomposite. In some embodiments, a wireless optoelectronic system comprising an RF harvesting unit is included that receives signals from a transmitter, rectifies them, multiplies the voltages, and routes the resulting direct-current output to the red LED. The device may be encapsulated with silicone elastomer and deployed between the skin and muscle (subcutaneously) into the patient, for example, while under anesthesia. Negligible degradations are expected when stored in phosphate-buffered saline and artificial perspiration (pH 4.3) for nine days at room temperature. The resulting wireless powering system enables precise and real-time control of illumination.

The electrical performance of PSPN material is further contemplated as an NFC antenna. For example, a fully stretchable wireless bioelectronic system may be fabricated from the PSPN for multiplexed biochemical sensing. The battery-free bioelectronic platform comprises a stretchable biochemical sensing interface (i.e., various biochemical sensors) and a spiral coil as the coupling unit for wireless data transmission. The design principles rely on a modularized inductor-capacitor (LC) resonance circuit model where varactors convert electrical potential variations into capacitance modulations. The latter are then quantitatively correlated with the resonance frequency shift fs of the LC circuit using the following equation:

$${f}_{s} = \frac{1}{2 π \sqrt{LC}}$$

where L and C are the inductance and capacitance of the resonance circuit, respectively. In the presence of targeted analytes, direct current (DC) bias generated between working and reference electrodes of the biochemical sensors can therefore be read from frequency shift. Since fs is an intrinsic property of the resonance circuit, it allows for robust and reliable wireless power delivery and data transmission.

In some embodiments, the PSPN with strain-invariant feature contributes to considerably improved stability of the wireless NFC data transmission system under strain. When the NFC antenna is subjected to uniaxial tensile stretch, a strain insensitivity of less than 10% performance variation is experienced when stretched up to 50% strain, i.e., from 0.68 to 0.62 MHz/decade. Note that the strain-induced performance changes arise primarily from change of device geometry that leads to degradation of coupling strength. On the contrary, the conventional nonporous Ag NWs, when under strain, the strain-induced performance instability may reduce from 0.64 to 0.45 MHz/decade at 15% and fail to operate at 20% strain. Furthermore, the devices retain their initial performance under repetitive strain cycles, as evidenced by about 3% and about 5% changes of sensitivity after cyclic stretching at 25% and 50% strains for 1,000 cycles.

The wireless sensor may be intimately attached on the neck of a patient due to the absence of on-chip integrated circuits and intrinsically soft and stretchable form factor. The battery-free device allows for real-time and continuous perspiration monitoring during daily life.

Embodiments of the present disclosure contemplated microscale self-assembly of Ag NWs, guided by multiscale porous elastomer matrices, by leveraging a facile phase separation process at ambient conditions. The self-organized selective distribution of Ag NWs on pore surface markedly reduce a percolation threshold (Vc=0.00062) and improve electrical conductivity over varying strain. The phase-separated soft and porous PU microstructure deforms and enables energy dissipation under large global strains, whereas the rigid Ag NWs adapt to the structural change and maintain its original percolation networks. This leads to strain-insensitive electrical conductivity while being stretched.

The superior electromechanical stability and electrical conductivity of the porous nanocomposites is contemplated for applications within NFC antenna for wearable and implantable devices. Further, battery-free wireless monitoring of a breadth of perspiration biomarkers with strain-insensitivity of less than 10% performance variation for up to 50% strain is achieved due to the strain-invariant properties of the porous microstructure. Further still, it should be understood that the phase separation technique described herein may open new avenues for constituent materials in different domains such as materials other than silver nanowire and polyurethane.

FIG. 9 illustrates an exemplary implantable biosensor device 120 relating to some embodiments of the present disclosure. The implantable biosensor device 120 may be implanted subcutaneously within a patient, such as, for example, along the spine of the patient, as shown. The exemplary implantable biosensor device 120 comprises a bioelectronic implant 122 coupled to a textile transmitter 124, as shown.

A cross-sectional view 126 of the exemplary implantable biosensor device 120 is shown such that the bioelectronic implant 122 can be seen disposed within the skin of the patient at a height, h, from the surface of the skin. Additionally, the textile transmitter 124 is formed to the curvature of the surface of the skin with a radius of curvature, r. Accordingly, in some embodiments, the textile transmitter 124 may comprise the porous nanocomposite material 20, as described above, such that the textile transmitter 124 is configured to stretch and flex to match the curvature of the surface of the skin of the patient. Additionally, the textile transmitter 124 may be configured to be stretched, curved, and bended along with the skin of the patient, for example, while the user moves, such that the patient does not experience discomfort. Alternatively, or additionally, embodiments are contemplated in which the biosensor device is worn externally on a patient's skin rather than implanted underneath or within the skin. For example, the biosensor may be coupled to an external surface of the skin via a suitable adhesive.

In some embodiments, the textile transmitter 124 is coupled to a signal generator 128, as shown. The signal generator 128 may be configured to generate a signal associated with the bioelectronic implant 122 and the textile transmitter 124. Further, in some embodiments, the signal generator 128 may transmit a wireless signal indicative of a measurement by the implantable biosensor device 120 to one or more external devices. Accordingly, measurements by the exemplary implantable biosensor device 120 may be received wirelessly, for example, using a Bluetooth (or other suitable wireless connection), by a user device, such as the user device 102, as described above.

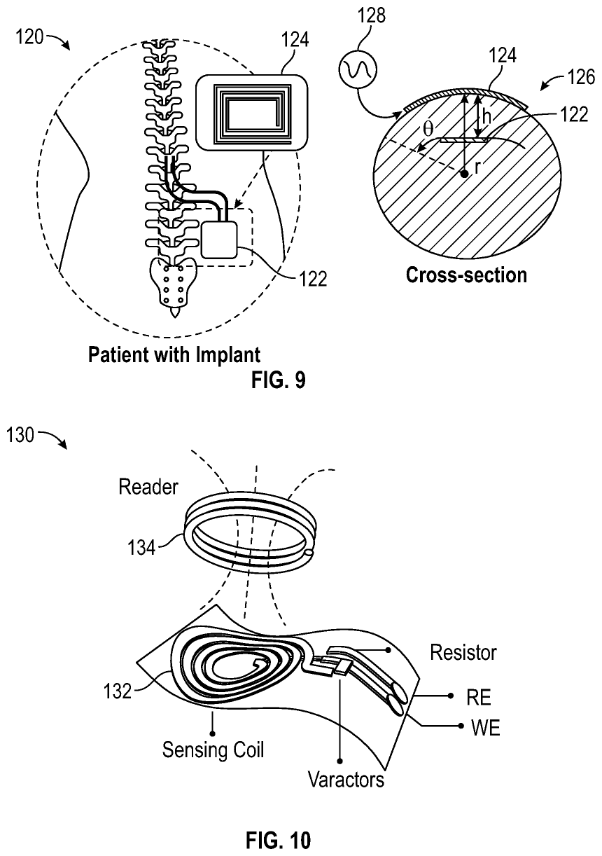

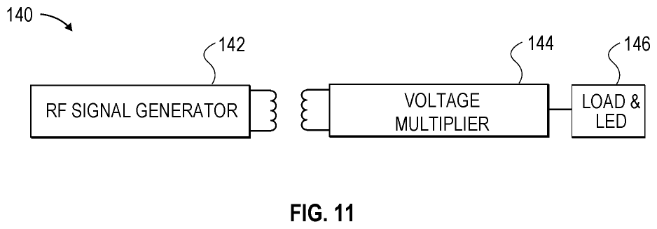

FIG. 10 illustrates an exemplary biochemical sensing device 130 relating to some embodiments of the present disclosure. The biochemical sensing device 130 comprises a sensing coil portion 132 and a reader portion 134, as shown. The sensing coil portion 132 may comprise a sensing coil, one or more resistors, and a plurality of varactors, as shown. In some embodiments, the sensing coil portion 132 is a flexible strip comprising the porous nanocomposite material 20 such that the sensing coil portion 132 is configured to stretch and bend along with a patient's skin or internal tissue while implanted or worn.

The reader portion 134 may comprises a reading coil configured to receive a signal from the sensing coil portion 132. For example, the sensing coil portion 132 may detect signals associated with the patient such as any of biochemical or bioelectrical parameters associated with the patient and transmit the signals to the reader portion 134. In some embodiments, the sensor coil portion 132 further comprises a plurality of electrodes including a reference electrode and a working electrode. Accordingly, in some embodiments, in the present of targeted analytes, direct current bias generated between the working electrode and the reference electrode may be read from a frequency shift.

FIG. 11 illustrates an exemplary implantable optoelectronic device 140 relating to some embodiments of the present disclosure. The implantable optoelectronic device 140 comprises a transmitter portion 142, such as, a radio frequency (RF) signal generator configured to generate RF signals for wireless transmission. Additionally, the implantable optoelectronic device 140 further comprises a receiver portion 144 with a voltage multiplier circuit, as shown, coupled to a load 146. In some embodiments, the load 146 further comprises a light emitting diode (LED) indicator device, for example, configured to indicate a state of the implantable optoelectronic device 140.

In some embodiments, the receiver portion 144 comprises a voltage multiplier circuit with a plurality of capacitors and diodes configured to multiply a voltage associated with the circuit. Further, in some embodiments, each of the transmitter portion 142 and the receiver portion 144 include at least one inductor configured to wirelessly transmit and receive signals to thereby provide a wireless communication connection between the transmitter portion 142 and the receiver portion 144.

In some embodiments, the bioelectronic devices described herein are configured to be imperceptible to human patients such as to not cause discomfort or other effects on the patient. Specifically, the bioelectronic devices include elastic strain-invariant structures that permit bending and natural dynamic movement of the patient without significant impact on performance of the bioelectronic device.

Above embodiments are described with respect to a porous silver nanowire composite, however, it should be understood that, in some embodiments, other suitable porous microstructure composites are also contemplated. For example, in some embodiments, a eutectic gallium indium (EGaln) may be used as the conductive filler solution. Accordingly, the EGaln substance may be embedded into the pores of the polymer substrate to provide strain-invariant electrical conductivity.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A bioelectronic device comprising:
a phase-separated porous silver nanowire nanocomposite (PSPN), the PSPN comprising:
an energy-dissipative porous microstructure configured to provide a strain-invariant electrical property of the PSPN, the energy-dissipative porous microstructure comprising:
a porous multiscale elastomer matrix; and
a plurality of silver nanowires disposed on a plurality of surfaces of the porous multiscale elastomer matrix.

2. The bioelectronic device of claim 1, the porous multiscale elastomer matrix comprises a polyurethane material.

3. The bioelectronic device of claim 1, wherein the bioelectronic device is configured to be integrated into a multiplexed biochemical sensing system.

4. The bioelectronic device of claim 1, further comprising:
a stretchable biochemical sensing interface formed of the PSPN; and
a spiral coil communicatively coupled to the stretchable biochemical sensing interface, the spiral coil configured to transmit and receive wireless signals.

5. The bioelectronic device of claim 1, further comprising:
a stretchable near-field communication (NFC) antenna formed of the PSPN.

6. The bioelectronic device of claim 1, wherein the PSPN has a percolation threshold below 0.01.

7. The bioelectronic device of claim 1, wherein the PSPN has a percolation threshold below 0.0007.

8. A method of fabricating a bioelectronic device, the method comprising:
preparing a precursor solution, the precursor solution comprising:
a polymer solution including a polymer and a solvent; and
a conductive filler solution including a plurality of silver nanowires and a nonsolvent;
heating or naturally drying the precursor solution to evaporate the solvent from the polymer solution,
wherein heating or naturally drying the precursor solution causes phase separation of the precursor solution into a polymer rich phase and a polymer poor phase; and
forming a phase-separated porous microstructure, the phase-separated porous microstructure comprising a strain-invariant electrical property and configured to be included in the bioelectronic device,
wherein the polymer poor phase forms a plurality of pores.

9. The method of claim 8, wherein the strain-invariant electrical property is an electrical conductivity of the phase-separated porous microstructure.

10. The method of claim 8, wherein the polymer comprises polyurethane and styrene ethylene butylene styrene.

11. The method of claim 10, wherein the solvent comprises tetrahydrofuran.

12. The method of claim 8, further comprising:
varying a volumetric ratio between the polymer solution and the conductive filler solution, wherein the volumetric ratio is selected based on one or more electrical properties for the bioelectronic device.

13. The method of claim 12, further comprising:
post-annealing the phase-separated porous microstructure, wherein a post-annealing temperature is selected based on the one or more electrical properties for the bioelectronic device.

14. A wearable wireless bioelectronic device comprising:
a phase-separated porous silver nanowire nanocomposite (PSPN), the PSPN comprising:
an energy-dissipative porous microstructure configured to provide a strain-invariant electrical conductivity of the PSPN, the energy-dissipative porous microstructure comprising:
a porous structure; and
a plurality of conductive nanostructures disposed on the porous structure.

15. The wearable wireless bioelectronic device of claim 14, further comprising:
a plurality of electrodes including a reference electrode and a working electrode.

16. The wearable wireless bioelectronic device of claim 14, wherein the wearable wireless bioelectronic device is configured to be integrated into a strain-insensitive wireless power system.

17. The wearable wireless bioelectronic device of claim 14, further comprising:
a voltage multiplier circuit configured to increase a voltage associated with the wearable wireless bioelectronic device.

18. The wearable wireless bioelectronic device of claim 14, wherein the wearable wireless bioelectronic device is a perspiration monitoring device configured to monitor perspiration of a patient in real-time based on one or more changes in glucose and ethanol concentrations.

19. The wearable wireless bioelectronic device of claim 14, wherein the wearable wireless bioelectronic device is a battery-free passive electronic device that is not coupled to a battery.

20. The wearable wireless bioelectronic device of claim 14, further comprising:
a Bluetooth low energy antenna configured to provide a wireless communication connection with one or more external devices.
